(19) United States
(12) Patent Application Publication
(10) Pub. No.: US 2022/0017696 A1
(43) Pub. Date: Jan. 20, 2022

(54) BIO-BASED NON-ISOCYANATE POLY(URETHANE-AMIDE) THERMOPLASTIC POLYMERS

(71) Applicant: CLEMSON UNIVERSITY RESEARCH FOUNDATION, CLEMSON, SC (US)

(72) Inventors: SRIKANTH PILLA, CLEMSON, SC (US); JAMES SCOTT STERNBERG, CLEMSON, SC (US)

(21) Appl. No.: 17/380,467

(22) Filed: Jul. 20, 2021

Related U.S. Application Data
(60) Provisional application No. 63/053,977, filed on Jul. 20, 2020.

(51) Int. Cl. C08G 71/04

(52) U.S. Cl. CPC C08G 71/04; C08L 77/06

(57) ABSTRACT

Disclosed are bio-based poly(urethane amide) polymers and methods for forming the polymers. The bio-based polymers can be synthesized through a ring opening reaction between bio-based cyclocarbonated polymers that include aromatic and/or cyclic functionality within the polymer and oligomeric polyamides. The cyclocarbonated polymers can be based on bio-based polyols, e.g., lignin or lignin-based polyols, and/or other aromatic or cyclic bio-based polyols. The oligomeric polyamides can be formed by reaction of one or more diamines, which can include bio-based diamines, and one or more dicarboxylic acids, which can include bio-based dicarboxylic acids.

### CROSS REFERENCE TO RELATED APPLICATION

This application claims filing benefit of U.S. Provisional Patent Application Ser. No. 63/053,977, entitled “Incorporation of Bio-Derived Aromatic Structures in Extended Polyamide Networks,” having a filing date Jul. 20, 2020, which is incorporated herein by reference in its entirety.

### BACKGROUND

Polyamides are typically produced from the condensation reaction between bifunctional carboxylic acids or halides and diamines that require precise reaction stoichiometry to reach large molecular weights. Unfortunately, typical polyamides exhibit undesirable properties such as high water adsorption and low melt viscosities. For instance, the amide groups present throughout the typical polyamide structure provide water binding sites that cause a plasticization effect leading to poor tensile properties and low glass transition temperature. Moreover, typical polyamides exhibit extremely low melt viscosities preventing use in many melt processing methodologies.

As a result of such issues, polyamides have been the subject of a great deal of research aimed at modifying the basic polyamide structure to create materials with improved processability and increased application opportunities. Modifications include increasing the molecular weight of the polymer chains through chain extension, branching and/or crosslinking. Traditional poly(urethane-amide) polymers have been developed in answer to such issues. Unfortunately, traditional poly(urethane-amide) materials are formed by use of petroleum-derived materials, such as diisocyanates, which have landed polyurethane-containing materials atop a list for the 50 most toxic polymers due to the diisocyanate formation route making use of the deadly gas phosgene. In addition, diisocyanates have been labeled a “CMR” (Cancer-causing, Mutagenic and Reproductive toxin) by the European community and have gained similar warnings in the United States.

The demand for environmentally benign material synthesis has grown in recent decades supported by the green chemistry movement as well as an interest in replacing petroleum-derived chemicals with materials derived from biomass. The high value and thermoplastic nature of polyamides creates a strong desire to provide environmentally friendly options for polyamide systems. The toxicity associated with petroleum resources, as well as a desire to lower the overall carbon footprint of industrial processes, has led efforts in support of the biorefinery concept in which natural materials are used as feedstock for chemical and material production. With the initial success of cellulosic ethanol production, including the benefits of lowering the mean ethanol selling price (MESP) to compete with petroleum-derived fuels, an increasing demand to valorize other biomass sources has gained momentum.

Chemistry associated with the synthesis of bio-based polyamide building blocks has emerged. For instance, amine-terminated oligomeric polyamides capable of curing aliphatic cyclocarbonated precursors toward the formation of a non-isocyanate poly(urethane-amide) has been reported (Poussard et al., Macromolecules 2016, 49 (6), 2162-2171). In this study, dicarboxylic acids were reacted with a slight excess of diamines to create long-chained polyamide oligomers. These oligomers were then reacted with carbonated soybean oil to create poly(urethane amide) networks.

While the above describes improvement in the art, room for further improvement exists. What are needed in the art are melt-processible bio-based poly(urethane amide) polymers that exhibit desirable physical characteristics for wide industrial application.

### SUMMARY

According to one embodiment, disclosed is a bio-based non-isocyanate poly(urethane amide) comprising the reaction product of a cyclocarbonated polymer and an amine-terminated oligomeric polyamide. A segment of the poly(urethane amide) derived from the cyclocarbonated polymer can include aromatic or cyclic functionality. The poly(urethane amide) can have a bio-based carbon content of about 90% or greater as determined by radiocarbon dating according to ASTM D866-20. In addition, the poly(urethane amide) can be a non-isocyanate polymer, and as such, can be free of any isocyanate reaction products.

According to one embodiment, disclosed is a method for forming a bio-based non-isocyanate poly(urethane amide). For instance, a method can include reacting an amine-terminated oligomeric polyamide with a bio-based cyclocarbonated polymer that includes aromatic or cyclic functionality within the polymer (i.e., in addition to the terminal cyclic carbonate functionality). In some embodiments, the amine-terminated oligomeric polyamide can also be bio-based. Methods can also include forming one or more of the amine-terminated oligomeric polyamide and the cyclocarbonated polymer. For instance, an amine-terminated oligomeric polyamide can be formed by reacting an excess of a diamine, e.g., a bio-based fatty-acid diamine, with a dicarboxylic acid, e.g., a bio-based dicarboxylic acid. In some embodiments, an amine-terminated oligomeric polyamide formation process can include reacting multiple different diamines, one or more of which can be bio-based, with one or more dicarboxylic acids, one or more of which can be bio-based. In some embodiments, a bio-based cyclocarbonated polymer can be formed by reacting a bio-based polyol that includes aromatic or cyclic functionality with a first organic carbonate to form an oxyalkylated polyol and then reacting the oxyalkylated polyol with a second organic carbonate.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 provides a general reaction scheme for synthesis of one embodiment of a poly(urethane-amide) polymer as disclosed herein.

FIG. 2 provides a flow diagram for one embodiment of a formation process for a bio-based poly(urethane amide).

FIG. 3 provides a reaction scheme for synthesis of one embodiment of a bio-based cyclocarbonate precursor.

FIG. 4 provides a rubric for synthesis of four different oligomeric polyamides utilized in formation of exemplary poly(urethane-amide) polymers as disclosed herein.

FIG. 5 provides Fourier-transform infrared spectroscopy (FTIR) results for several oligomeric polyamides (OPAs) synthesized as described herein.

FIG. 6 provides differential scanning calorimetry (DSC) traces for OPAs synthesized as described herein.

FIG. 7 provides DSC traces of a second heating cycle for OPAs synthesized as described herein.

FIG. 8 proved a DSC trace of the second heating cycle of an OPA synthesized as described herein.

FIG. 9 provides FTIR results for a cyclocarbonated lignin precursor, and OPA, and several poly(amide-urethane) polymers as disclosed herein.

FIG. 10A provides FITR results for poly(amide-urethane) polymers as disclosed herein.

FIG. 10B provides FITR results for poly(amide-urethane) polymers as disclosed herein.

FIG. 11A provides curing rheology data of a reaction mixture including cyclocarbonated lignin and an OPA as described herein.

FIG. 11B provides curing rheology data of a reaction mixture including cyclocarbonated lignin and another OPA as described herein.

FIG. 11C provides curing rheology data of a control reaction mixture including Kraft lignin and an OPA as described herein.

FIG. 12A provides rheological strain sweeps of several poly(amide-urethane) polymers formed with an OPA as disclosed herein.

FIG. 12B provides rheological strain sweeps of additional poly(amide-urethane) polymers formed with the OPA of the networks of FIG. 11A.

FIG. 13A provides rheological strain sweeps for additional poly(amide-urethane) polymers formed with another OPA as disclosed herein.

FIG. 13B provides rheological strain sweeps for poly(amide-urethane) polymers formed with another OPA as disclosed herein.

FIG. 13C provides rheological strain sweeps for poly(amide-urethane) polymers formed with the same OPA as used in the materials of FIG. 12B.

FIG. 13D provides rheological strain sweeps for poly(amide-urethane) polymers formed with another OPA as disclosed herein.

FIG. 14A rheological frequency sweeps for poly(amide-urethane) polymers formed with an OPA as disclosed herein.

FIG. 14B rheological frequency sweeps for poly(amide-urethane) polymers formed with the OPA of the polymers of FIG. 13A.

FIG. 14C rheological frequency sweeps for poly(amide-urethane) polymers formed with the OPA of the polymers of FIG. 13A.

FIG. 15A provides rheological frequency sweeps of poly(amide-urethane) polymers formed with another OPA as disclosed herein.

FIG. 15B provides rheological frequency sweeps of poly(amide-urethane) polymers formed with another OPA as disclosed herein.

FIG. 15C provides rheological frequency sweeps of poly(amide-urethane) polymers formed with another OPA as disclosed herein.

FIG. 16 provides comparison of the storage modulus of different poly(am ide-urethane) polymers as disclosed herein.

FIG. 17A provides complex viscosity data for OPAs as described herein.

FIG. 17B provides complex viscosity data for poly(amide-urethane) polymers as disclosed herein.

FIG. 17C provides complex viscosity data for poly(amide-urethane) polymers as disclosed herein.

Repeat use of reference characters in the present specification and drawings is intended to represent the same or analogous features or elements of the present invention.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

The present disclosure is directed to bio-based poly(urethane amide) polymers that exhibit characteristics suitable for use in melt processing applications and methods for forming the polymers. The bio-based polymers can be synthesized through a ring opening reaction between bio-based cyclocarbonated polymers that include aromatic and/or cyclic functionality within the polymer and oligomeric polyamides (OPA). The cyclocarbonated polymers can be based on bio-based polyols, e.g., lignin or lignin-based polyols, and/or an aromatic or cyclic polyols derived from bio-based processes, such as the processing of fatty acids from algae, animal, or vegetable origins; bacterial processes that produce a mixture or selective number of polyols; and from production of polyols (e.g., diols) from bio-based aromatic or cyclic carbohydrates. The oligomeric polyamides can be formed by reaction of one or more diamines, which can include bio-based diamines, and one or more dicarboxylic acids, which can include bio-based dicarboxylic acids.

The bio-based content, as well as the thermoplastic nature of disclosed materials, can provide a desirable combination of processability, product characteristics and renewability in a bio-based polyamide polymer. The use of a cyclocarbonated precursor that includes aromatic or cyclic functionality in the polymer in formation of the polyamide systems resembles the addition of chain extenders and crosslinkers employed in traditional polyamides and can increase melt viscosity and bead strength for extrusion practices as well as provide desirable mechanical characteristics of products formed form the polymers. The concentration of the cyclocarbonate can be used to control properties of the resulting poly(urethane amide) polymers based on the competitive reactions that occur in the reactive system. The correct application of these parameters can lead to materials with greater processability and better mechanical properties.

Disclosed methods and materials combine the environmental benefits of using bio-based precursors with manufacturing benefits gained with a melt-processable material. The viscosity and thermoplastic nature of the materials enables their use in modern industrial processing techniques such as extrusion, thermoforming, and injection molding. Beneficially, disclosed materials not only address the need to form poly(urethane amide) thermoplastic materials from bio-based sources, but also address the need for greater processability of typical polyamides. For instance, disclosed materials can exhibit increased viscosity and melt strength that can overcome difficulties encountered with commodity polyamides, such as polyamide 6-6 (PA6,6) and polyamide 6-10 (PA6,10).

Through use of bio-based precursors, the polymeric products can exhibit very high bio-based content. For instance, a bio-based precursor can have a bio-based carbon content of about 95% or greater, or about 98% or greater in some embodiments. A poly(urethane amide) formed from the bio-based precursors can have a bio-based carbon content of about 90% or greater, about 92% or greater, about 95% or greater, or about 98% or greater, in some embodiments. The bio-based carbon content can be calculated based on known procedures; for instance, by use of the procedure of Pan et al. (Biomacromolecules 12, 2416-2428 (2011)) by relating the total amount of bio-renewable carbon to the total amount carbon present in a formulation. The bio-based carbon content can optionally be determined in some embodiments by radioactive carbon dating, for instance according to ASTM D6866-20.

Disclosed poly(urethane amide) polymers can exhibit a storage modulus (E′) of about 0.01 MPa or greater, such as about 0.1 MPa or greater in some embodiments, and can exhibit a loss modulus (E″) of about 0.01 MPa or greater, such as about 0.1 MPa or greater in some embodiments. The complex viscosity of a poly(urethane amide) as determined at an angular frequency of 1 rad/s can be about 1,000 Pa·s or greater, such as about 10,000 Pa·s or greater, or about 100,000 Pa·s or greater in some embodiments.

Poly(urethane amide) polymers disclosed herein can exhibit desirable melt temperatures, for instance so as to be suitable for use in existing melt-processing applications. For instance, a poly(urethane amide) can have a melt temperature of about 200° C. or less, about 150° C. or less, about 125° C. or less, or about 100° C. or less in some embodiments.

Disclosed polymers can also exhibit a beneficial linear viscoelastic region (LVR). The LVR of polymers represents the range where the polymer structure remains intact and can be found where the storage and loss modulus remain substantially constant under increasing strain. The yield point (γ_{y}) is generally defined where this linear behavior ceases, and both the loss and storage modulus begin to decrease as a result of fractures developing in the polymer matrix. At higher strains, rigid polymer structures break down further and begin to flow past one another. The flow point (γ_{f}) is generally defined at the crossover between loss and storage modulus. In the present case, poly(urethane amide) polymers as disclosed can exhibit a LVR at a strain value from 0 to about 10%, to about 5%, to about 1%, or to about 0.5%.

Disclosed materials can also exhibit low water adsorption. For instance, disclosed materials can exhibit adsorption in water over 24 hours, as determined according to ASTM D570, of about 5% or less, about 3% or less, or about 2% or less in some embodiments.

In addition to other benefits, the bio-based poly(urethane amide) polymers described herein can exhibit excellent recyclability. Without wishing to be bound to any particular theory, it is believed that the use of bio-based precursors, such as the use of an organic carbonate in formation of a cyclocarbonate precursor, can extend nascent hydroxyl groups of the polyol, as well as create ether and carbonyl groups, on the backbone of the polyol that are capable of being used in subsequent chemical recycling steps as “molecular zippers” that can provide a route to not only breaking down a poly(urethane amide) in a degradation reaction, but can also provide for recovery of precursor materials in a high quantity so as to provide a circular lifecycle to use the recycled precursors in the same or other applications.

For instance, using a hydrolysis recycling technique including processing at a temperature of from about 200° C. to about 250° C. for reaction periods of from about 1 to 6 hours, bio-based poly(urethane amide) polymers as described herein can be treated to recover from about 60 wt. % to about 85 wt. % of a bio-based precursor and convert from about 60 wt. % to about 75 wt. % of the total polymer waste material. A combined hydrolysis/glycolysis recycling technique can utilize a reaction system including a stabilizer such as ethylene glycol, formaldehyde, or bio-based alcohols in an amount of about 5-20 wt. % (e.g., 10 wt. %), and an alkaline catalyst such as a potassium hydroxide solution at from about 0.05 M to about 2.5 M (e.g., 1 M-2 M) at a reaction temperature of from about 200° C. to about 250° C. for reaction periods of from about 1 to 6 hours, bio-based poly(urethane amide) polymers can be treated to recover from about 70 wt. % to 100 wt. % of the bio-based precursors and convert from about 70 wt. % to about 95 wt. % of the total waste material. Moreover, the natural degradation pathways present in the structure of polyols such as lignin have been shown to create unique handles that can undergo chemical conversion and degradation with the application of hydrolysis.

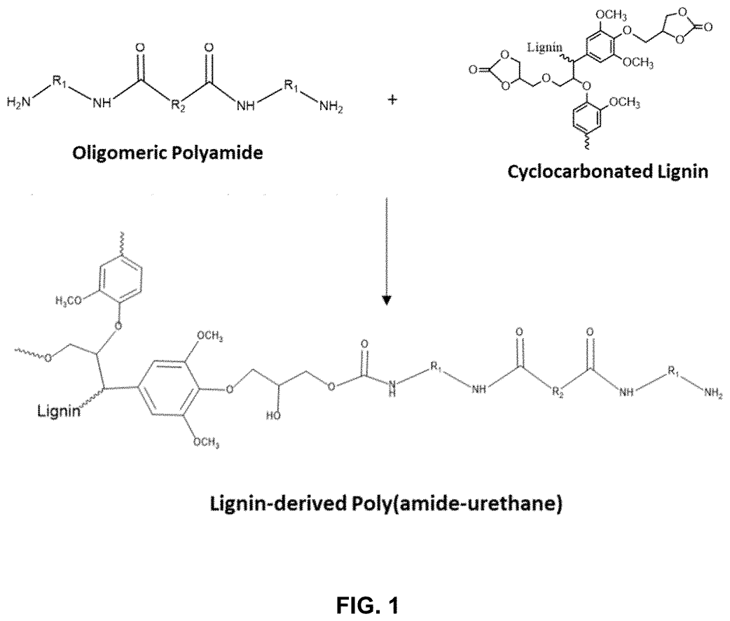

In one embodiment, a poly(urethane amide) can be formed by reaction between an amine-terminated OPA and a cyclocarbonated lignin, though, and as discussed further herein, the cyclocarbonate precursor of the formation process is not limited to lignin or lignin-based materials. FIG. 1 provides a general reaction scheme for such an embodiment. As shown, reaction between the OPA and the cyclocarbonate can create urethane bonds throughout the polymer structure.

Precursors used to form a bio-based poly(urethane amide) can include one or more OPAs that can be formed from one or more diamines reacted with one or more dicarboxylic acids. In one embodiment, the diamine precursor can include a bio-based diamine, and in one particular embodiment, a fatty acid-based polyvalent, e.g., dimer, diamine. In one embodiment, the diamine component can be composed of 100% bio-based carbon, e.g., a 100% bio-based carbon fatty acid dimer diamine.

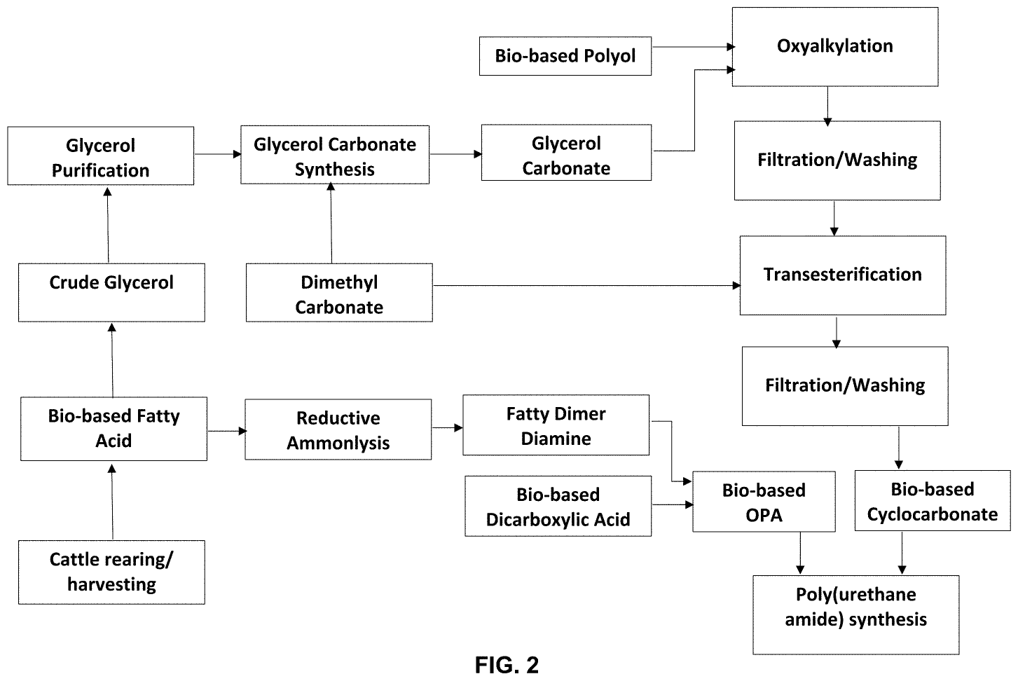

Optionally, a formation protocol can be free of the use of any petroleum-based precursors, which can increase the bio-based carbon content of the product polymer. For instance, FIG. 2 presents one embodiment of a formation process that can utilize starting materials that are entirely bio-based. By way of example, animal-based starting materials can be derived from animal processing/rendering plants, such as in the cattle rearing/harvesting industry or any other animal processing facility including, without limitation, cattle, pig, chicken, fish, sheep, etc. processing, as well as combinations of animal-derived feedstock materials. Animal processing facilities can provide organic materials for use in formation of organic carbonates used in production of a bio-based precursors, as well as providing fatty acids for production of a fatty-acid based diamine precursor.

As indicated in FIG. 2, to form an OPA for a formation reaction, a diamine precursor can be reacted with a dicarboxylic acid precursor. In one embodiment, the diamine precursor can be represented by the following structure:

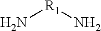

in which R₁ may include a C1 to C20 linear alkyl group.

In one embodiment, a diamine can be a polyvalent diamine represented by the following structure:

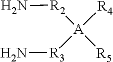

in which A is a tetravalent saturated hydrocarbon residue, and may be a linear structure or a ring structure; for instance, a C1 to C4 linear structure, R₂ and R₃ are an alkylene group, e.g., a C1 to C20 alkylene group, and R₄ and R₅ are a linear alkyl group, e.g., a C1 to C20 linear alkyl group.

For instance, and without limitation, R₂ and R₃ can be selected from methylene, ethylene, propylene, butylene, pentylene, etc. and may be the same or different from each other. R₄ and R₅ can be selected from, and without limitation to, methyl, ethyl, propyl, butyl, a pentyl etc. and R₄ and R₅ may be the same or different from each other. In some embodiments, the carbon chain(s) of the diamine can be relatively long; for instance, a C14 to C18 alkyl chain.

In one embodiment, a diamine can be a bio-based diamine derived from a fatty acid. For instance, a bio-based fatty acid dimer diamine can be utilized that can be formed by reductive ammonolysis of dimer fatty acids produced as an animal processing by-product, as indicated in FIG. 2. As utilized herein, the term “fatty acid” generally refers to naturally occurring and synthetic monobasic aliphatic acids having hydrocarbon chains of 8 to 24 carbon atoms. Fatty acids can include saturated, ethylenically unsaturated, and acetylenically unsaturated acids.

A diamine can be a diamine of a polyvalent fatty acid. As utilized herein, the term “polyvalent fatty acid” generally refers to dimerized fatty acids, trimerized fatty acids, and higher polymers of fatty acids, respectively. The saturated, ethylenically unsaturated, and acetylenically unsaturated fatty acids are generally polymerized by somewhat different techniques, but because of the functional similarity of the polymerization products, they are all generally referred to as “polyvalent fatty acids.”

For instance, saturated fatty acids can be polymerized at elevated temperatures with a peroxidic catalyst such as di-t-butyl peroxide to form a polyvalent fatty acid, e.g., a dimer fatty acid. Exemplary saturated fatty acids as may be utilized in forming a fatty acid diamine include branched and straight acids, such as caprylic acid, pelargonic acid, capric acid, lauric acid, myristic acid, palmitic acid, isopalmitic acid, stearic acid, arachidic acid, behenic acid and lignoceric acid. As a commercial example, Priamine™ (available from Croda Japan Co., Ltd.) is mentioned.

A polyvalent, e.g., dimerized fatty acid can be converted to the corresponding dinitrile by reacting the dimerized fatty acid with ammonia under nitrile forming conditions as is known in the art. The dinitrile can then be purified by vacuum distillation or other suitable means. After such purification, the dinitrile can be hydrogenated to form the dimer diamine which can also be purified by vacuum distillation or other suitable means.

Of course, a diamine for use in a formation protocol is not limited to fatty acid diamines, or fatty acid dimer diamines, and other, more traditional diamines as are known in the art can be utilized, optionally in conjunction with a fatty acid diamine and/or a fatty acid dimer diamine, though use of such may lower the bio-based carbon content of a poly(urethane amide) product, depending upon the source materials used in forming the diamine. Examples of diamines that can be utilized can include, but are not limited to, ethylene diamine, 1,2- and 1,3-propylene diamine, tetramethylene diamine, hexamethylene diamine, octamethylene diamine, 1,2-diaminocyclohexane, 1,3-bis(aminomethyl)cyclohexane, decamethylene diamine, N,N′-dibutyl hexamethylenediamine, N,N′-dimethyl hexamethylenediamine, N,N′-dihexyl hexamethylenediamine, 1,12-dibutylaminododecane, 1,10-dibutylaminodecane, N,N′-didodecyl hexamethylenediamine, N,N′-dibutyl butylenediamine, N,N′-dibutyl ethylenediamine, N,N′-diisobutyl butylenediamine, and combinations thereof.

As stated, combinations of diamines may be utilized so as to modify one or more characteristics of the OPA and/or the poly(urethane amide). For instance, in some embodiments, a fatty acid-based diamine can be combined with a more traditional diamine to provide an OPA precursor having a desirable characteristic, e.g., a melt temperature, for further processing in formation of a poly(urethane polymer). For instance, an OPA precursor can be formed so as to have particular characteristics for reaction with a bio-based cyclocarbonate and/or for use with solvents and/or to encourage reaction under reaction conditions used in formation of the poly(urethane amide).

By way of example, a fatty acid-based diamine and a second diamine (e.g., a second fatty acid-based diamine or a traditional diamine, which can be either bio-based or petroleum-based) can be combined in a weight ratio of from about 99:1 to about 1:99, for instance, from about 15:85 to about 35:65 in some embodiments, or from about 40:60 to about 60:40 in some embodiments, such as about 25:75, about 75:25, or about 50:50 in some embodiments.

To form an OPA, the diamine component can be reacted with a dicarboxylic acid component. In some embodiments, a dicarboxylic acid can be bio-based, or can include combinations of dicarboxylic acids, which can include combinations of bio-based and petroleum-based dicarboxylic acids, combinations of bio-based dicarboxylic acids, or combinations of petroleum-based dicarboxylic acids.

Examples of suitable dicarboxylic acids can include aliphatic diacids, which can include linear or branched aliphatic (either saturated or unsaturated), aromatic, cyclic or combinations thereof. Particular examples of dicarboxylic acids can include, without limitation, oxalic acid, adipic acid, azelaic acid, sebacic acid, dodecanedioic acid, 2,6-naphthalene acid dicarboxylic acid, 1,4-cyclohexane dicarboxylic acid, heptanedioic acid, undecanedioic acid, brassylic acid, tetradecanedioic acid, hexadecanedioic acid, octadecanoic acid, eicosanedioic acid, docosanedioic acid, isophthalic acid, terephthalic acid, furan dicarboxylic acid, and cycloaliphatic diacids, such as, for example, cyclohexanedicarboxylic acid (CHDA).

Selection of dicarboxylic acids or combinations thereof can be utilized to modify the characteristics of the OPAs and the resulting poly(urethane amides). For instance, utilization of a dicarboxylic acid having a relatively short aliphatic chain, e.g., about C8 or less, can be utilized to increase overall strength characteristics and enhance rigidity of the resulting poly(urethane amide). Use of a longer chained aliphatic dicarboxylic acid, for instance about C10 or greater, can decrease the melt temperature of the OPA precursor, which may be advantageous in some embodiments.

Reaction conditions for forming an OPA are understood by one of skill in the art and can generally include heating the diamine and dicarboxylic acid constituents to a suitable dissolution temperature and holding the mixture at a reaction temperature of, e.g., about 200° C. or less for a suitable reaction period. To ensure that the resulting OPAs are amine-terminated, the reactants can be combined with a slight excess of diamine. For instance, in a molar ratio of about 1.1:1 or greater, e.g., from about 1.1:1 to about 1.5:1. The reaction conditions can produce OPAs having a relatively low molecular weight, e.g., a weight average molecular weight of about 10,000 or less, about 5,000 or less, or about 4,000 or less in some embodiments.

The “weight average molecular weight” (Mw) is readily calculated by one of ordinary skill in the art, and generally refers to:

$${\overline{M}}_{w} = \frac{{\sum }_{i} {N}_{i} {M}_{i}^{2}}{{\sum }_{i} {N}_{i} {M}_{i}}$$

where Nᵢ is the number of molecules of molecular weight Mᵢ. The weight average molecular weight can be determined by light scattering, small angle neutron scattering (SANS), X-ray scattering, gel permeation chromatography, and sedimentation velocity.

Utilization of a low molecular weight oligomer in a formation process can be advantageous in some embodiments, as it can ensure a high number of terminal amine groups for reaction with the cyclocarbonate precursor during formation of a poly(urethane amide).

As indicated in FIG. 2, an OPA can be reacted with a bio-based cyclocarbonate precursor to form a bio-based poly(urethane amide). In one embodiment, a bio-based cyclocarbonate can be formed from starting materials that are entirely bio-based. The bio-based cyclocarbonate can include aromatic and/or cyclic functionality that will remain in the poly(urethane amide) reaction product, i.e., aromatic and/or cyclic functionality that is in addition to the terminal cyclocarbonate functionality of the precursor.

A bio-based cyclocarbonate precursor can be formed through reaction of a bio-based polyol with a cyclocarbonate. It should be understood that, while illustrated in FIG. 2 as a bio-based glycerol carbonate, the cyclocarbonate reactant is not limited to this particular material or the formation method indicated on FIG. 2 and a cyclocarbonate precursor can be formed according to any suitable methodology and sourced from any suitable starting material for use in disclosed processes and products.

A bio-based polyol used in forming a bio-based poly(urethane amide) can encompass any bio-based polyol including aromatic and/or cyclic groups within the polymer. A suitable polyol can include at least two hydroxyl termini optionally in conjunction with other termini (e.g., in a branched network). A polyol can encompass both linear and branched systems, as well as homopolymers or copolymers. A polyol for use as disclosed can include aliphatic, aromatic, or cyclic components in any combination, e.g., aromatic and/or cyclic components in conjunction with a linear aliphatic component in a linear or branched system.

In one embodiment, a lignin-containing feedstock can be utilized to provide a polyol in forming a bio-based poly(urethane amide). A lignin-containing feedstock such as may be obtained from a wood processing operation can be utilized to provide the bio-based polyol component. In such an embodiment, lignin from any lignocellulosic biomass source material can be utilized, including both woody and non-woody sources. Woody lignocellulosic biomass can be sourced from forests, agriculture, or any other source and can encompass hardwood and/or softwood source materials. For example, fast-growing tree species, such as hybrid willow (Salix) and poplar as have been developed for production in agricultural settings, can be utilized.

Agriculture systems can be a source of non-woody lignin or other polyol biomass source materials. Agricultural systems can produce several different types of non-woody lignocellulosic biomass materials including primarily cellulosic materials such as plant leaves and higher lignin-content materials such as stems and stalks. For example, harvesting of cereals, vegetables, and fruits can provide lignocellulosic polyol biomass source materials. Agricultural residues including field residues and processing residues can provide lignocellulosic polyol source materials. Field residues include materials left in an agricultural field after harvesting the crop, and can include, without limitation, straw and stalks, leaves, and seed pods. Processing residues, such as husks, seeds, bagasse, and roots, include those materials left after the processing of the crop into a desired form. Examples of agricultural residue source materials can include, without limitation, rice straw, wheat straw, corn stover, and sugarcane bagasse.

Other waste streams, such as municipal waste, construction waste, sawmill waste, etc., can provide a lignocellulosic polyol biomass source material. For instance, yard waste, holiday waste, etc. can provide a lignocellulosic polyol source material in some embodiments.

Perennial and annual grasses can provide aromatic and/or cyclic polyol source materials. Examples of grass source materials can include, without limitation, switchgrass (Panicum virgatum), miscanthus (Miscanthus spp. Anderss.), canary grass (Phalaris arundinacea), giant reed (Arundo donax L.), alfalfa (Medicago sativa L.), sorghum (Sorghum bicolor), and Napier grass (Pennisetum purpureum).

Vegetable oils can be a source for aromatic or cyclic bio-based polyols for creation of the bio-based precursors. Edible or non-edible oils, as well as animal and/or algal lipids, can be used as source for bio-based polyols. Bacterial processes can also produce aromatic and/or cyclic polyols capable of further functionalization. Carbohydrates, such as naturally produced carbohydrates (e.g., C3 to C12 carbohydrates), can also be a source of polyols (e.g., diols) through the known reduction reaction.

An industrial lignin obtained by a Kraft pulping process can be utilized in some embodiments. By way of example, a lignin feedstock can be obtained from Kraft pulping produced by precipitation of a lignin-containing portion of the black liquor. In such an embodiment, the precipitate can include a lignin feedstock for disclosed methods. Such a black liquor precipitation process can separate a portion of the impurities contained in the black liquor, such as ash, metals, hemicellulose, etc., from the lignin feedstock. For example, a black liquor may be subjected to carbon dioxide and/or sulfuric acid acidification to precipitate out a lignin feedstock, leaving impurities behind in the remaining liquor portion. Of course, such a precipitation treatment is not limited to Kraft Black Liquor source materials.

In another embodiment, an alkaline liquor obtained from processing of a source material such as an agricultural residue (e.g., corn stover) can be pretreated via acidification with an inorganic or organic acid, which can precipitate out a lignin-containing feedstock, leaving impurities behind in the remaining alkaline liquor.

In one embodiment, a lignin feedstock can be utilized that has not been subjected to further processing, e.g., a Kraft lignin with a relatively high polydispersity index that has not been subjected to fractionation or depolymerization preprocessing. For instance, a bio-based polyol feedstock can have a polydispersity index of about 2 or greater, or about 3 or greater in some embodiments.

As utilized herein, the polydispersity index (PDI) refers to a measure of the distribution of molecular mass in a given polymer sample. The PDI calculated is the weight average molecular weight divided by the number average molecular weight. It indicates the distribution of individual molecular masses in a polymer sample. The PDI has a value equal to or greater than 1, but as the polymer chains approach uniform chain length, the PDI approaches unity (i.e., 1).

The “number average molecular weight” (Mn) is readily calculated by one of ordinary skill in the art, and generally refers to the ordinary arithmetic mean or average of the molecular weights of the individual macromolecules. It is determined by measuring the molecular weight of n polymer molecules, summing the weights, and dividing by n, such as represented in the formula:

$${\overline{M}}_{n} = \frac{{\sum }_{i} {N}_{i} {M}_{i}}{{\sum }_{i} {N}_{i}}$$

where Ni is the number of molecules of molecular weight Mi. The number average molecular weight of a polymer can be determined by gel permeation chromatography, and all colligative methods, like vapor pressure osmometry or end-group determination.

In other embodiments, a depolymerized lignin, e.g., a lignin-based oil, can be utilized as a bio-based polyol feedstock that can be formed from an unprocessed lignin, e.g., a Kraft lignin, according to methods as are known in the art including, without limitation, hot water treatment, steam treatment, thermal treatment, chemical treatment, biological treatment, catalytic treatment, or combinations thereof.

In some embodiments, the polyol feedstock can be processed to form a cyclocarbonated bio-based precursor that can then be utilized in a ring opening reaction of cyclic carbonates of the precursor with an OPA to form a poly(urethane amide) as indicated in the exemplary reaction scheme of FIG. 1. The bio-based cyclocarbonate precursor can be formed through reaction of an aromatic and/or cyclic polyol feedstock with one or more carbonates, which can increase the reactivity of the bio-based polyol precursor toward the OPA.

In one embodiment, organic carbonates can be utilized in forming the cyclocarbonate precursor (e.g., rather than metal carbonates). In addition, the unwanted homopolymerization of propylene oxide (often used to make more reactive precursors) can be avoided with the use of a well-controlled reaction of organic carbonates.

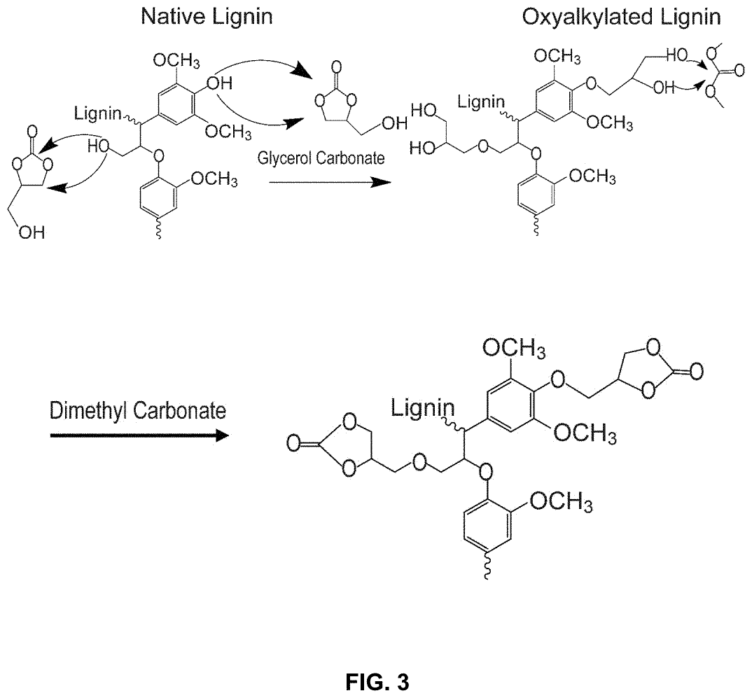

As indicated in FIG. 3 for the particular example of a lignin-based precursor, a cyclocarbonated bio-based precursor can be formed according to a two-step reaction process, the first of which can form an oxyalkylated polyol. According to this first reaction, the hydroxyls of a polyol feedstock can react with an organic carbonate to incorporate liable ether and carbonyl groups on the backbone of the polyol while terminating the chain extended precursor in a 1,2-diol (FIG. 3). In one embodiment, the organic carbonate can be a bio-based carbonate derived from a natural resource, rather than a petroleum-based carbonate, which can increase the bio-based carbon content of the bio-based precursor, as well as that of a poly(urethane amide) product formed from the precursor.

As indicated in FIG. 2, in one embodiment, a glycerol carbonate can be utilized to obtain the cyclocarbonate groups, and the glycerol carbonate can be derived from bio-based glycerol obtained from animal fat. Bio-based glycerol as produced from plant oil can also be utilized in forming a bio-based glycerol carbonate. For instance, glycerol can be obtained from a natural resource by a hydrolysis reaction as is generally known in the art. Hydrolysis is a known process that includes reacting plant oil or animal fat with water to break down the plant oil or animal fat into free fatty acid and glycerol. Optionally, a catalyst can be employed in the reaction. Further, the reaction can include the application of heat to accelerate the reaction. Following, a bio-based glycerol can be reacted with a dialkylcarbonate, for example, dimethyl carbonate as illustrated in FIG. 2, or a cyclic alkylene carbonate, to form a bio-based glycerol carbonate. As previously indicated, other organic carbonates can alternatively be utilized. For instance, the functionalization agent can be a cyclic organic carbonate having the general structure:

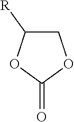

in which R is H, or C1 to C18 alkyl or C1 to C19 alcohol.

Examples of cyclic organic carbonates can include, without limitation, ethylene carbonate, propylene carbonate, 1,2- or 2,3-butylene carbonate, etc., as well as combinations of cyclic organic carbonates.

Non-cyclic carbonates can alternatively be utilized, as well as combinations of cyclic and non-cyclic carbonates. Non-cyclic organic carbonates can include, without limitation, dimethyl carbonate or other dialkyl carbonates. Examples of organic carbonate reactants can include, without limitation, dimethyl carbonate, diethyl carbonate, di (n-propyl) carbonate, di (iso-propyl) carbonate, di (n-butyl) carbonate, di (sec-butyl) carbonate, di (tert-butyl) carbonate, or dihexyl carbonate.

The organic carbonate of the oxyalkylation reaction step can generally be provided in an amount of from about 5 equivalents to about 15 equivalents, based upon the hydroxyl content of the polyol; for instance, about 10 equivalents organic carbonate according to the hydroxyl content of the polyol, in one embodiment.

The oxyalkylation reaction can utilize a catalyst as is known in the art. In one embodiment, the catalyst can be a non-metallic catalyst, e.g., a non-metallic bio-based catalyst. Examples of non-metallic catalysts for an oxyalkylation reaction can include, without limitation, 1,8diazabicyclo[5.4.0]undec-7-ene (DBU), triethylamine, 1,5,7-triazabicyclo[4.40]dec-5-ene (TBD), 2-chloro-4,4,5,5-tetramethyl-1,3,2-dioxaphospholane, etc. In general, a catalyst can be employed in an amount of about 0.1 equivalents or less according to the hydroxyl content of the polyol; for instance, about 0.05 equivalents in one embodiment.

In some embodiments, the oxyalkylation can be carried out at a relatively low temperature, for instance at about 160° C. or less, or from about 130° C. to about 155° C., e.g., about 150° C. in some embodiments and for a relatively short period of time, from about 1 hour to about 2 hours, or about 1.5 hours in some embodiments.

In some embodiments, the molecular weight of the polyol feedstock can decrease over the course of the oxyalkylation reaction, which is evidence of the good balance between condensation and fractionation that can be attained by the reaction. For instance, the weight average molecular weight (Mw) of the oxyalkylated polyol can be about 90% or less of that of the polyol of the feedstock; for instance, about 80%, or less or about 70% or less. In some embodiments, the Mw of the oxyalkylated polyol can be from about 50% to about 70% of the Mw of the polyol feedstock.

Following an oxyalkylation reaction step, the oxyalkylated polyol, which has a 1,2-diol functionalized structure, can be further processed to insert cyclocarbonate structures on the backbone. This can be carried out by a transesterification reaction of the oxyalkylated polyol with a second organic carbonate. The organic carbonate of the transesterification reaction can be the same as or different from the organic carbonate utilized in the oxyalkylation reaction.

The organic carbonate of the transesterification reaction step can generally be provided in an amount of from about 3 equivalents to about 10 equivalents, based upon the hydroxyl content of the polyol; for instance, about 5 equivalents organic carbonate according to the hydroxyl content of the polyol, in one embodiment.

Control of the catalyst loading, reaction temperature, and reaction time can be utilized to provide a bio-based precursor that can exhibit high reactive functionality content that is available for the further polymerization reaction. For instance, an alkaline catalyst can be used including, without limitation, alkali-metal hydroxides, such as potassium, sodium or lithium hydroxides; salts of an alkali-metal and a weak acid, such as sodium carbonate, potassium carbonate, etc.; alkaline salts such as trisodium phosphate; alkali-metal alcoholates, such as sodium methoxide, potassium ethoxide, sodium ethoxide; organic bases, such as the quaternary ammonium bases, including the mixed alkyl-dimethyl-benzyl ammonium hydroxides, the alkyl-trimethyl ammonium hydroxides and tetra-alkyl quaternary ammonium hydroxides, such as tetramethylammonium hydroxide, cetyldimethylbenzyl-ammonium hydroxide, etc.; or the alkali metal sucrates or raffinates, such as sodium sucrate, sodium, raflinate, etc. Additionally, metals, such as tin and zinc, may be employed as catalyst for the transesterification reaction.

The catalyst of the transesterification reaction step can generally be provided in an amount of about 1 equivalents or less, based upon the hydroxyl content of the polyol; for instance, from about 0.2 equivalents catalyst to about 0.7 equivalents, or about 0.4 equivalents according to the hydroxyl content of the polyol, in one embodiment.

The transesterification cyclic carbonate insertion reaction can be carried out at a temperature of about 100° C. or less, or from about 60° C. to about 90° C., e.g., about 75° C. in some embodiments and for a period of time from about 3 hours to about 6 hours, or about 4 hours in some embodiments.

A bio-based precursor can have high reactivity. For instance, a bio-based cyclocarbonate precursor can have a cyclic carbonate content of from about 1.8 mmol cyclic carbonate per gram total polyol or greater, such as from about 1.8 to about 2.25 mmol cyclic carbonate per gram starting polyol, or about 2 mmol cyclic carbonate per gram polyol in one embodiment. In addition, the cyclic carbonate can be accessible to OPA during the poly(urethane amide) formation process, which can be evidenced by the molecular weight of the cyclocarbonate precursor, as it can be lower than the molecular weight of the polyol feedstock utilized to form the precursor. For instance, the Mw of the bio-based cyclocarbonate precursor can be from about 70% to about 95% of the Mw of the polyol of the feedstock, or from about 80% to about 90% in some embodiments, such as about 85%. In some embodiments, a bio-based cyclocarbonate precursor can have a weight average molecular weight of about 15,000 or less, about 14,500 or less, or about 14,000 in some embodiments and can have a number average molecular weight of about 4,000 or less, about 3,500 or less, or about 3,400 in some embodiments.

The OPA and cyclocarbonate precursors can be combined in a predetermined ratio to form a poly(urethane amide) of desirable characteristics. For instance, the bio-based cyclocarbonate can generally be incorporated in the polymer product at a weight percentage of from about 10 wt. % to about 60 wt. %, or from about 15 wt. % to about 50 wt. % in some embodiments. Depending upon the particular nature of the cyclocarbonate precursor (e.g., branching and existing reactivity of the polyol component), at high add-in levels, the poly(urethane amide) reaction can lead to high crosslinking in the product which can be beneficial to increase melt viscosity and storage modulus, but may be undesirable if too high, as this can lead to more thermoset-like behavior of the products.

Reactivity between disclosed cyclocarbonated and OPA precursors can provide for poly(urethane amides) exhibiting thermoplastic properties with desirable and controllable thermal and rheological properties. Beneficially, disclosed bio-based polymers can exhibit properties for application with existing processing equipment according to traditional thermal processing. By way of example and without limitation, disclosed poly(urethane amide) polymers can be subjected to shaping processes for forming articles including, without limitation, extrusion, injection molding, blow-molding, thermoforming, compression molding, hot-stamping, pultrusion, and so forth. Shaped articles that may be formed may include structural and non-structural shaped.

The thermoplastic character of disclosed polymers can decrease the high cost barrier and capital expenses often associated with bio-based polymer systems. In addition, the low water adsorption and ability to tune the final properties based on precursor content can make these material attractive for use in a plurality of different applications where a range of properties are needed to meet component specifications.

The present disclosure may be better understood with reference to the Examples set forth below.

### Example 1

Oligomeric polyamides (OPA) were synthesized in a nitrogen environment by loading the diamine and dicarboxylic acid in a molar ratio of 1.2:1 to produce amine terminated chains. The diamine (Priamine™ 1074 (PR) or hexamethylene diamine (NMDA)) and carboxylic acid (sebacic acid (SA) or adipic acid (AA)) were loaded in a round bottom flask and allowed to reach dissolution at 160° C. The temperature was then increased to 190° C. and the reaction was allowed to continue for 3 hours. When completed, the molten product was poured in a silicon mold and allowed to cool to room temperature.

To synthesize poly(urethane-amide) polymers, 1 g of OPA was added to a vial and heated to its melting point. Cyclocarbonated lignin (CC lignin) was first dissolved in dimethyl sulfoxide (DMSO) according to the ratio of 1 g CC lignin:1.3 mL DMSO. After dissolution, the lignin solution was heated to the same temperature as the molten OPA and added to the vial. The weight percentage CC lignin was varied based the total mass of OPA plus CC lignin to form different networks for comparison. The two components were stirred for 2-3 minutes and then poured in an aluminum or silicon mold and allowed to cure in an oven at 120° C. to 150° C. for 12 hours. If the solvent was not completely removed from the system after 12 hours, additional heating under vacuum was used to dry the sample.

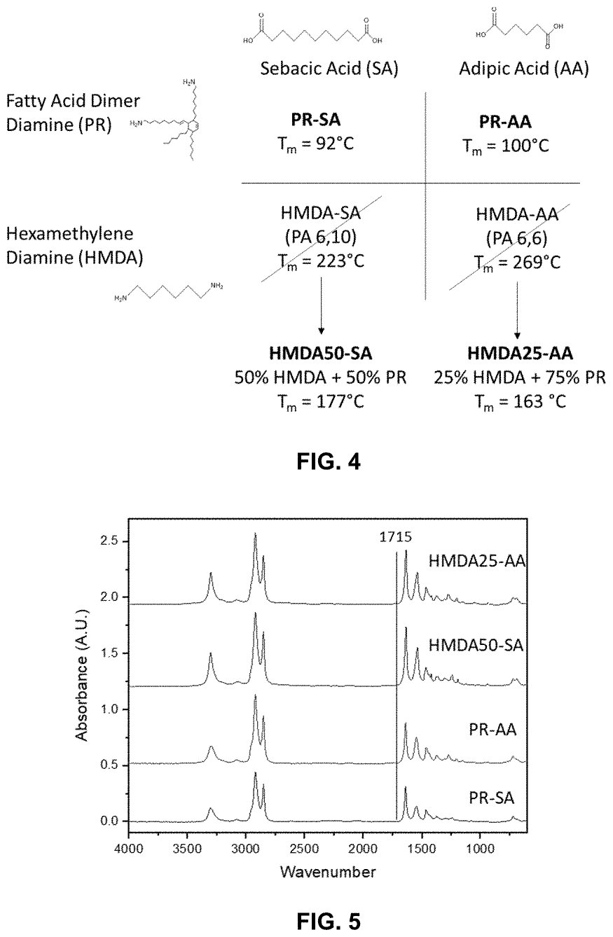

Initially, low Tₘ OPAs were synthesized from a slight excess of fatty acid-based dimer diamine (PR) and either bio-based sebacic acid (C-10; SA) or adipic acid (C-6; AA). From these two relatively low melting point precursors (˜90-100° C.; PR-SA and PR-AA), a second set of higher melting point oligomers were synthesized by mixing different feed ratios of hexamethylene diamine (HMDA) (25 wt. % and 50 wt. %) and the fatty acid-based dimer diamine (PR) (75 wt. % and 50 wt. %) with adipic acid or sebacic acid to create PA6,6 and PA6,10 analogues with melting points below 190° C. The scheme for the synthesis of 4 different OPAs is described in FIG. 4. As shown in FIG. 4, OPAs formed of HMDA and either SA or AA exhibited melting points higher than desired for this particular example as oligomers were targeted for a melting point no higher than the 190° C. threshold based on the boiling point of the solvent (DMSO) used to ensure a homogeneous mixture between CC lignin and the OPA.

After the synthesis of the OPAs, CC lignin was added from 15-65 wt. % with the aid of DMSO and these materials were cured for 12 hours between 120° C.-150° C. as described above.

The success of the OPA formation reaction was verified by FTIR monitoring the disappearance of the carboxylic carbonyl group at 1715 cm⁻¹ and the appearance of the amide band at 1650 cm⁻¹ as well as secondary amine stretch at 3300 cm⁻¹ (FIG. 5). As can be seen with reference to FIG. 5, the spectra for all OPAs showed very similar characteristics using FTIR.

The extent of the polyamide reaction was measured for the low melting point samples (PR-SA, PR-AA) through an amine titration to measure the concentration of amine-terminated species present in the OPA. The addition of HMDA to the PR to form HMDA50-SA and HMDA25-AA resulted in insoluble materials due to the high chemical resistivity of typical polyamides. The titration of amine groups was completed by the addition of a standardized solution of HCl to a solution of PR-SA or PR-AA dissolved in a 1:1 mixture of hot isopropyl alcohol and toluene. Bromocresol green was used to determine the end point of the titration, and three runs were completed to determine an average value. The result shown in Table 1 below show similar values for both PR-SA (0.235 mmol/g) and PR-AA (0.272 mmol/g) and agree well with the value obtained by the HCl titration (0.236 mmol/g).

Table 1 also displays the molecular weight of the PR-SA and PR-AA OPAs as determined by gel permeation chromatography (GPC). A molecular weight of around 3500 corresponds to a degree of polymerization between diamine and diacid of around 4. These molecular weights are much lower than typical polyamides which reach into the 20-30 kDa region. However, the low molecular weights presented here are part of the reaction design to increase the amount of chain terminated amine groups capable of reacting with CC lignin.

TABLE 1

| | Amine Value | | | |
|---|---|---|---|---|
| OPA | (mmol/g) | M_{w} | Mₙ | Tₘ (° C.) |
| PR-SA | 0.235 | 3200 | 1200 | 92 |
| PR-AA | 0.272 | 3600 | 2900 | 101 |
| | CC groups | | | CC groups/ |
| Lignin | (mmol/g) | M_{w} | T_{g} | lignin |
| CC-Lignin | 2.0 | 14,000 | 151 | 28 |

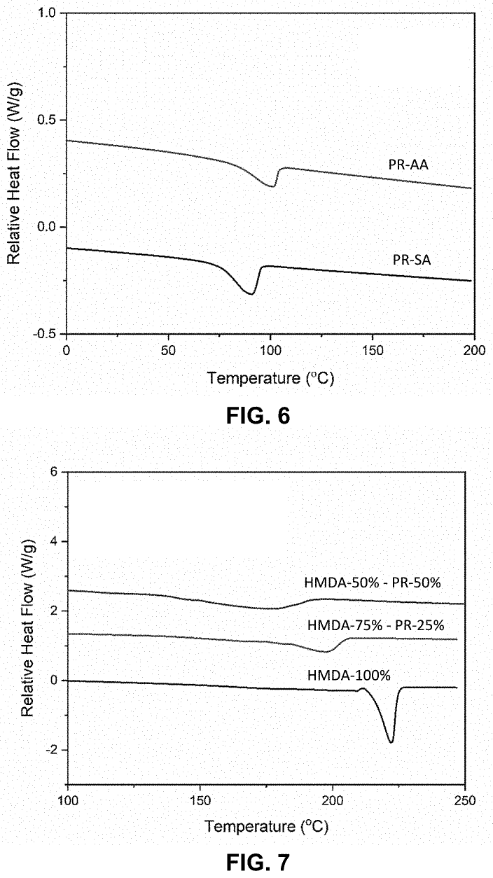

The reaction of the fatty acid diamine (PR) and adipic acid or sebacic acid resulted in homogenous PR-AA or PR-SA OPAs with melting points near 100° C. A slightly lower Tₘ was observed for PR-SA given the long aliphatic chain (C-10) present in sebacic acid compared to adipic acid (C-6). DSC traces of these two OPA materials are presented in FIG. 6.

The reaction design for the high melting point OPAs (HMDA50-SA, HMDA25-AA) centered around finding the correct feed ratio of the diamine component to synthesize an OPA with a melting point below 190° C. Initial attempts using 100% HMDA and sebacic acid (SA) resulted in an OPA with a melting point (Tₘ=222° C.) near traditional PA6,10. Replacing 25% of the HMDA component with the long chained fatty acid-based diamine PR decreased the Tₘ to 198° C., still outside the window necessary for the synthetic protocol using DMSO. However, when 50% of the HMDA was replaced with the fatty acid-based diamine, a broad melting endotherm (FIG. 7) was observed in DSC with a Tₘ identified at 177° C., suitable for solubilizing with CC lignin. The new OPA, termed HMDA50-SA, did show some small additional phases with shoulder endotherms on the main melting peak, yet these were on the low temperature side of the melting event positioning HMDA50-SA for use in the experimental design.

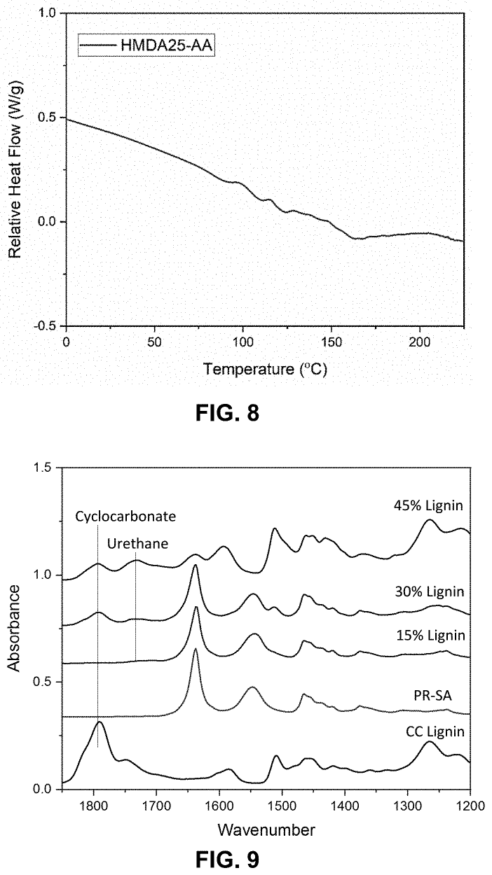

As the combination of HMDA and SA initially resulted in high melting point OPAs, the combination of HMDA and AA was expected to present further challenges. The use of AA creates higher melting point polyamides just as the Tₘ of PA6,6 (˜270° C.) is above that of its SA derivative, PA6,10 (˜223° C.). Seeing that 50% of HMDA in HMDA-SA needed to be replaced with the fatty acid-based diamine to find Tₘ below 190° C., an OPA was synthesized using 25% HMDA, 75% PR, and AA as the dicarboxylic acid. The result was HMDA25-AA with Tₘ=163° C., albeit with many other phases present in the structure (FIG. 8). The DSC trace for HMDA25-AA shows multiple melting endotherms resulting from phases composed of varying degrees of HMDA and PR as diamine component. The heterogenous nature of this sample would prove difficult to characterize during rheological treatment due to side reactions occurring at the high temperatures used during experiments.

Traditionally, the amine value of the OPA would be used to determine the stoichiometric amount of the complimentary precursor to synthesize cured resins. However, as lignin is a polyfunctional compound, it could be incorporated into the polymeric structure to various degrees. Given the molecular weight of the cyclocarbonated lignin measured at 14,000 g/mol and the concentration of cyclocarbonate groups at 2.0 mmol/g lignin (Table 1), this equates to approximately 28 cyclocarbonate groups on each macromolecular structure of lignin. Using the amine value of 0.235 mol/kg for PR-SA, a stoichiometric amount of CC groups and amine groups was reached a 10.5 wt. % lignin incorporation. Thus, lignin was incorporated from 15-45 wt. % in all OPAs and up to 65 wt. % in PR-SA to test the stability of the system at maximum concentration of lignin. At these percentages, each lignin molecule contains sites of reactivity with the amine-terminated OPA and CC sites that go unreacted on lignin's structure. However, the ratio between amine groups and CC groups is always maintained so that each lignin molecule can participate in the new polymer structure. The ratio of CC groups to amine groups is demonstrated for each reaction formulation in Table 2, below and shows that the ratio never exceeded 28:1, the maximum value before entire molecular structures of lignin would go unreacted.

TABLE 2

| | Cyclocarbonate: Amine Ratio | | | |
|---|---|---|---|---|
| OPA | 15% Lingin | 30% Lingin | 45% Lingin | 65% Lingin |
| PR-SA | 1.5:1 | 3.7:1 | 7.0:1 | 15.7:1 |
| PR-AA | 1.3:1 | 3.2:1 | 6.0:1 | — |

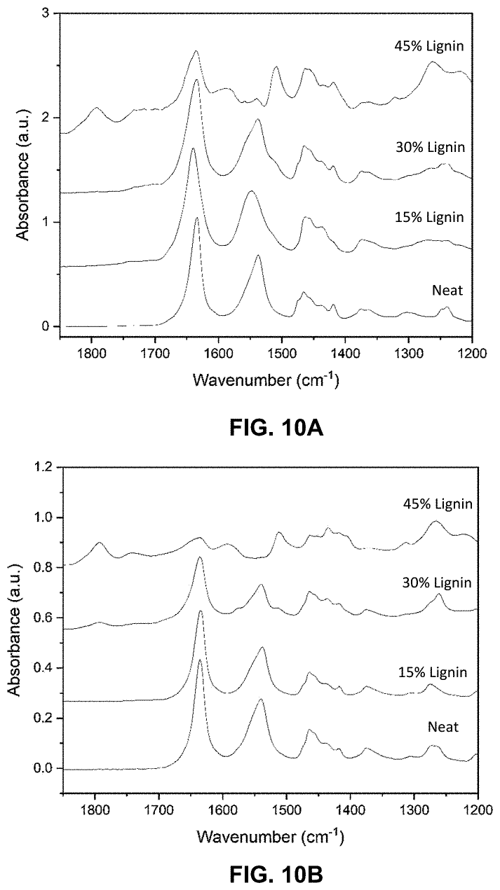

The reaction of cyclocarbonate groups and amines was monitored using FTIR by following the conversion of the cyclocarbonate peak observed at 1795 cm⁻¹ to that of the urethane carbonyl at ˜1720 cm⁻¹. The reaction of PR-SA was chosen as the model formulation to study this reactivity based on the very similar structures between PR-SA and PR-AA. The presence of the urethane signal was an important parameter witnessing to the formation of a new chemical structure present in the polymer as opposed to the formation of a polyamide blend with lignin. FIG. 9 shows the evolution of the urethane peak as the concentration of lignin increases from 15 wt. % to 45 wt. %. The presence of both cyclocarbonate groups and urethane signals corresponds to the theoretical structure shown in FIG. 1 and the above discussion of the ratio of CC-to-amine groups. The increase in lignin percentage also gives rise to the characteristic peaks associated with the lignin aromatic backbone shown at 1500 cm⁻¹ and 1270 cm⁻¹ and a decrease in the amide peak associated with the OPA present at 1650 cm⁻¹. The broad nature of the urethane peak is a sign of the different chemical environments of the urethane bond as a result of lignin's heterogenous structure as well as the different hydrogen bonding interactions resulting from the new hydroxyl group formed from the ring-opening reaction of the CC group (FIG. 1). The FTIR results thus support the understanding of reactivity between OPA and CC lignin, confirming the presence of the presented chemical structure in the creation of a lignin-derived poly(amide-urethane) network. Similar FTIR spectra were obtained for the high temperature versions of the CC lignin-OPA reaction (HMDA50-SA; FIG. 10A and HMDA25-AA; FIG. 10B) revealing a similar evolution of the urethane peak.

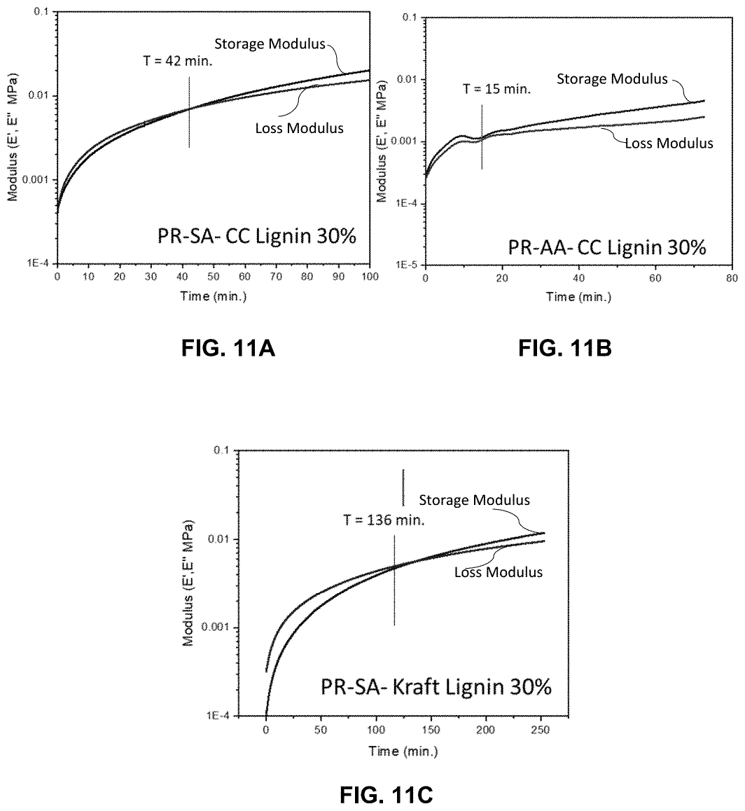

The reactivity between CC lignin and the amine-terminated OPA was further characterized by monitoring the curing reaction with 30 wt. % lignin through rheology. Experiments were carried out by forming mixtures of the OPA and CC lignin with the help of a small amount of DMSO and transferring the mixture to a parallel plate rheometer set at the curing temperature of 120° C. The gel point of the reaction was determined by finding the crossover point between the storage and loss modulus. Experiments were only carried out for the low temperature OPAs as the high temperature OPAs solidify at 120° C.; therefore, the points where storage modulus (E′), which represents the elastic component of material behavior, and loss modulus (E″), which represents the viscous component of material behavior, reach the crossover point were obscured. In addition, a control experiment was carried out using raw Kraft lignin combined with the OPA per the reaction procedure described above. The control experiment represented a material in which lignin was physically blended with the OPA. However, given the various chemical groups present on lignin, as well as the propensity of lignin to undergo molecular arrangements at elevated temperatures, some crosslinking was still expected to occur. FIGS. 11A-11C display the result of the rheological analysis taken during the curing reaction. The reaction between CC lignin and PR-SA (FIG. 11A) reached a gel point at 42 minutes, as well as both E′ and E″ recording values above 10⁻² MPa after just 100 minutes. Conversely, the control reaction with PR-SA and unmodified Kraft lignin (FIG. 11C) reached a gel point after 136 minutes and reached a modulus of 10⁻² MPa after 250 minutes. The gel time of the control reaction was more than 3 times longer than the reaction with CC lignin pointing to the efficient reaction of CC groups and amines in the reaction mixture. An even more dramatic result was observed for the reaction mixture containing PR-AA (FIG. 11B). The reaction of CC lignin and PR-AA recorded values for the storage modulus above the loss modulus from T=0, yet a curing event was observed around T=10 minutes with diverging E′ and E″ values from T=15 minutes onward. The faster gel time observed for PR-AA is most likely due to the higher amine value associated with this OPA (Table 1, 0.235 vs. 0.272 mmol/g). The rheological experiments conducted during the curing reaction complimented the findings from FTIR that CC lignin and the amine-terminated OPA successfully react creating new chemical linkages in the form of urethane bonds. This chemical structure results in significant changes to the viscoelastic behavior of the materials showing stronger networks formed in the polymer structure.

Soxhlet extraction of the cured material was carried out in triplicate for resins containing PR-SA and lignin concentrations between 15 wt. %-45 wt. %. The results showed an increase in the residual amount with increasing lignin concentration. At 15 wt. % lignin concentration, an average of 26.0% crosslinked residual material was recovered whereas at 30 wt. % and 45 wt. % lignin, this amount increased to 60.6% and 64.4% respectively. These results reflect the incorporation of lignin in the polymer structure at both low and high lignin concentrations as well as point to a plateau with regard to the amount of lignin that can be incorporated.

The bio-based content of an optimized formulation (PR-SA-30 wt. %) of the lignin-derived poly(amide-urethane) was measured using radiocarbon analysis according to ASTM 6866. The analysis determined the percent modern carbon (pMC) content by measuring the ¹⁴C/C¹² ratio of a sample and comparing to a standard with known bio-content established by the National Institute of Standards and Technology (NIST). PR-SA-30 wt. % was synthesized with a bio-based diamine from fatty acids, sebacic acid sourced from castor oil, and CC lignin sourced from an industrial pulping facility. The analysis reported a pMC content for the novel material of 99%. The small amount of petroleum-based carbon was most likely a result of the organic carbonates used in lignin functionalization as well as the catalyst (TBD) used in the curing reaction. Although organic carbonates have renewal sources for their synthesis, they are often synthesized from petroleum-based sources.

Melting points and heat of fusion values (ΔH_{f} (J/g)) for each cured resin were gained from the second heating cycle of DSC analysis and are presented in Table 3, below. The general trend was observed that increasing lignin concentration resulted in a decrease in the melting point as well as a decrease in the crystallinity (smaller ΔH_{f} values) compared to the neat polyamide (only samples resulting from low Tₘ OPAs had measured ΔH_{f} values due to the multiple endotherms present in the high Tₘ OPAs). The two results were complimentary: As the lignin content increased and disrupted the orderly arrangement of the OPA, the melting point was lowered as well as the overall crystallinity of the sample. In addition, the presence of crosslinking created amorphous phases that do not have a distinct Tₘ and further decreased the ΔH_{f}. It is understood that the polyfunctional nature of lignin and the increased concentration of amine-terminated OPAs gave rise to significant crosslinking. In addition to the data gained from Soxhlet extraction, the rheological analysis presented below also points to a significant effect of crosslinking in the polymers.

TABLE 3

| | PR-SA | PR-AA | HMDA | HMDA |
|---|---|---|---|---|
| Lignin | Tₘ (° C.)/ | Tₘ (° C.)/ | 50-SA | 25-AA |
| (wt. %) | ΔH_{f} (J/g) | ΔH_{f} (J/g) | Tₘ (° C.) | Tₘ (° C.) |
| 0 | 92.1/15.4 | 100.4/10.6 | 177.0 | 162.9 |
| 15 | 89.7/15.6 | 89.8/7.7 | 168.3 | 148.8 |
| 30 | 85.8/10.8 | 85.5/4.4 | 169.6 | 157.0 |
| 45 | 85.2/4.5 | 86.6/5.0 | 154.2 | 143.7 |

The DSC results presented here are important to the objective of creating a lignin-derived thermoplastic as the preservation of the melting point, albeit with lowered crystallinity, represents the thermoplastic character of the lignin-derived poly(amide-urethane) networks.

The technique of direct adsorption in water over 24 hours was used according to ASTM D570 to analyze the water adsorption characteristics of the materials. The results (Table 4) correspond well to established equilibrium values for PA6,6 and PA6,10 as provided by a commercial manufacturer showing that PA6,6 typically has higher adsorption rates than PA6,10 due to a higher concentration of amide bonds. The synthesized OPA PR-SA described herein shows very little water adsorption corresponding to the hydrophobic nature of the fatty acid-based diamine used in its synthesis. This fatty acid-based diamine is a C-36 molecule composed of multiple long chained hydrophobic hydrocarbons. With the addition of lignin, a slight increase in the water adsorption was observed based on lignin's own tendency to adsorb water. The lignin used in this study has been reported to contain up to 30 wt. % water, although it was dried before use in this polymer synthesis. The low water adsorption demonstrated by PR-SA-30 wt. % reflects the successful reactivity between PR-SA and CC lignin creating a homogeneous polymer structure with low water adsorption. Indeed, the reaction of CC lignin with the amine-terminated OPA resulted in the formation of additional hydroxyl groups capable of hydrogen bonding throughout the polymer structure (FIG. 1). Hydrogen bonding interactions with ether, carbonyl, amide, and urethane groups limit their ability to bind water molecules, leading to more hydrophobic properties. The low water adsorption of the lignin-derived poly(amide-urethane) networks is an example of their relevance to high performance applications.

TABLE 4

| | Water |
|---|---|
| Sample | Adsorption (wt %) |
| PR-SA | 0.51 ± 0.21 |
| PR-SA-30 | 1.62 ± 0.23 |
| wt. % Lignin | |
| PA6,6 | 3.21 ± 0.30 (2.0) |
| PA6,12 | 1.53 ± 0.81 (1.5) |

Chemical recycling was utilized to revert the cured material back to its chemical precursors to demonstrate a closed-loop lifecycle for the bio-based material. CC lignin contains an abundance of natural C—O bonds that can be exploited for chemical breakdown, as well as the inclusion of ether and carbonyl units from the functionalization with organic carbonates. Hydrothermal treatment using 0.1 M KOH at 220° C. for three hours was applied to the poly(amide-urethane) containing PR-SA and 30 wt. % lignin after successful results were found using alkaline catalysts on other polyamide systems. The technique resulted in the recovery of 74±4% of the lignin from the cured polymer samples. In addition, the procedure resulted in a split phase system where lignin remained dissolved in the aqueous phase while the polyamide remained solidified at the top of the mixture. These results exist as a proof of concept demonstrating the ability to chemically recycle the bio-based material.

Rheological experiments of cured materials were carried out to explore the thermal and mechanical properties of polymers containing different compositions of lignin. Strain sweeps were conducted at 10 rad/s from at 0.1% to 100% strain to evaluate the extent of the linear viscoelastic region (LVR) in each polymer composition.

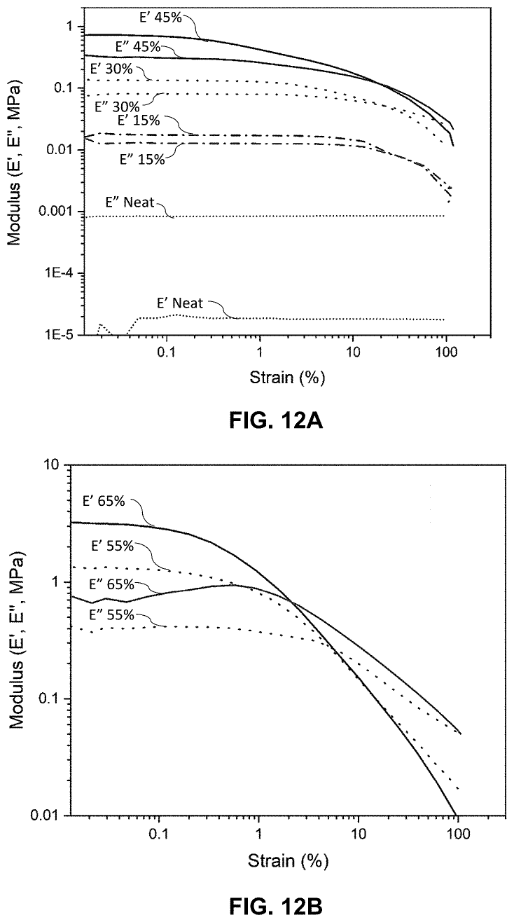

FIG. 12A and FIG. 12B show the result from strain sweeps of polymers composing PR-SA containing 0 to 65 wt. % lignin. Starting with the neat OPA, a characteristic LVR was observed for all strain values representative of a liquid polymer melt where the viscous response dominates the mechanical characteristics of the material. When 15 wt. % lignin was added to the polymer structure, a more solid-like character is observed with E′ above E″, as well as the emergence of a limited LVR up to about 10% strain. With higher contents of lignin (30 wt. %, 45 wt. %), both modulus values increase, as well as a corresponding decrease in the LVR to about 1% and 0.1% strain, respectively. The decrease in the LVR is a result of increased crosslinking and rigidity formed with higher contents of lignin. The high molecular weight and multifunctional structure of lignin created multiple points for crosslinking as well as disrupting the natural crystallinity of the OPA. The gradual slope associated with the end the LVR observed for materials with 15-45 wt. % lignin points to a homogeneous yield process where the natural molecular interactions were somewhat preserved during the transition to brittle behavior. For these compositions, a similar flow point was reached at between 15-35% strain. On the contrary, when the lignin content was increased to 55 wt. % and 65 wt. %, a much more dramatic transition to the nonlinear region was observed (FIG. 12B) reflecting the highly rigid nature of polymer structure and the sudden onset of fracturing in the polymer structure. The flow point was reached much sooner in these materials at 2.5% and 5% strain for 55 wt. % and 65 wt. % lignin, respectively. Therefore, at 55 wt. % and 65 wt. % lignin, the new polymer showed unstable characteristics unlikely to be useful in materials of high value. However, the data for the rheological strain sweeps do reveal that lignin could be incorporated to various degrees with variation to the final properties of the material.

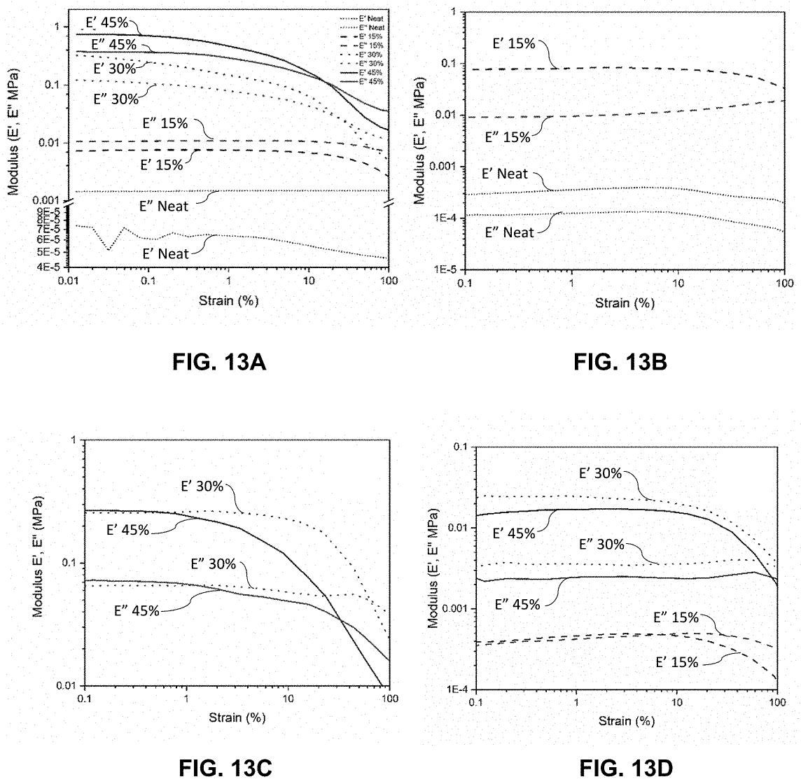

Strain sweeps for polymer compositions containing other OPAs (FIG. 13A (PR-AA), FIG. 13B (HMDA50-SA; neat and 15 wt. % CC lignin), FIG. 13C (HMDA50-SA; 30 wt. % and 45 wt. % CC lignin), and FIG. 13D (HMDA25-AA)) followed the same trends observed for PR-SA in FIG. 12A and FIG. 12B. Large increases in modulus were found between the neat samples and 15 wt. % lignin as with the increase to 30 wt. % lignin. Between 30 wt. % and 45 wt. % lignin, very similar values were observed. Once again, polymers composed of HMDA25-AA showed anomalous behavior with E′ values for 30 wt. % lignin above those for 45 wt. % lignin (FIG. 13D).

For all polymer compositions, a relatively large increase in the modulus was observed between samples with 15 wt. % and 30 wt. % lignin. From 30 wt. % to 45 wt. % lignin, a smaller increase is observed. Given the extended LVR associated with samples composing 30 wt. % lignin, the strain sweep experiments gave a preliminary identification of the lignin composition resulting in polymers with enhanced properties. Corresponding to the results from the Soxhlet extraction, at 30 wt. % lignin, sufficient crosslinking had occurred to enhance the polymer structure without compromising the homogeneous nature of the network. At 45 wt. % lignin, the concentration of the rigid nature of the lignin aromatic backbone began to impact negative qualities to the polymer structure in the form of excessively brittle characteristics.

Table 5 displays the yield point and flow point of each polymer composition used in this study.

TABLE 5

| | | | | | HMDA50- | | HMDA25- | |
|---|---|---|---|---|---|---|---|---|
| | PR-SA | | PR-AA | | SA | | AA | |
| Lignin | Strain (%) | | Strain (%) | | Strain (%) | | Strain (%) | |
| (wt.%) | [symbol] _{y} | [symbol] _{f} | [symbol] _{y} | [symbol] _{f} | [symbol] _{y} | [symbol] _{f} | [symbol] _{y} | [symbol] _{f} |
| 15 | 5 | 35 | 11 | n/a | 5 | n/a | 3 | 7 |
| 30 | 1.25 | 22 | .02 | 20 | 2 | 67 | 8 | 100 |
| 45 | 0.08 | 15 | .05 | 12.5 | .26 | 30 | 5 | 96 |
| 55/65 | 0.08/ | 4/2.5 | — | — | — | — | — | — |
| | 0.05 | | | | | | | |

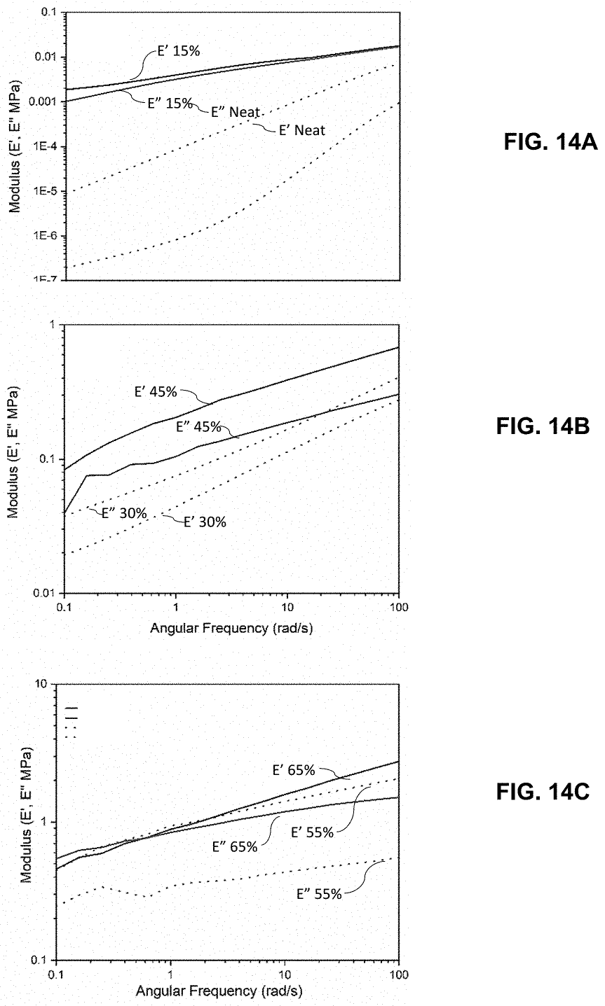

Frequency sweeps of the cured polymers were completed at 0.1 to 100 rad/s using a strain value from the linear viscoelastic region determined for each polymer. Starting with polymers composed of PR-SA, the neat OPA displayed typical liquid behavior with E″ above E′ (FIG. 14A-FIG. 14C). According to linear viscoelastic behavior, E′ should show proportionality to ω² (angular frequency) while E″ should vary as ω. The result of this relationship is the separation of E′ and E″ by at least an order of magnitude for linear polymers following a typical LVR. While the neat polyamide obeys this relationship (FIG. 14A), the reaction with CC lignin creates a new structure with solid-like behavior where E′ is above E″ and the proportionality to ω is lost. The reaction with 15 wt. % CC lignin increases the value of the storage modulus by 4 orders of magnitude (FIG. 14A), while an increase of 1 order of magnitude is observed between 15 wt. % and 30 wt. % lignin (FIG. 14A, FIG. 14B) and smaller increases at higher lignin concentration. As the lignin content increases to the highest values (45 wt. %-65 wt. %; FIG. 14B-FIG. 14C), some inhomogeneity was observed through the jagged curves found at low angular frequency. In addition, no increase in E′ was observed between 55 wt. % and 65 wt. % lignin compositions (FIG. 14C). A homogeneous sample is represented by the smooth curves associated with the 30% sample (FIG. 14B), a result of the polymer exhibiting similar relaxation times with small changes in angular frequency. The jagged curves associated with samples above 30 wt. % lignin refer to rigid phases in the polymer unable to dissipate the energy associated with low frequency movement. These curves become smoother at higher frequencies, most likely due to a sheer thinning effect.

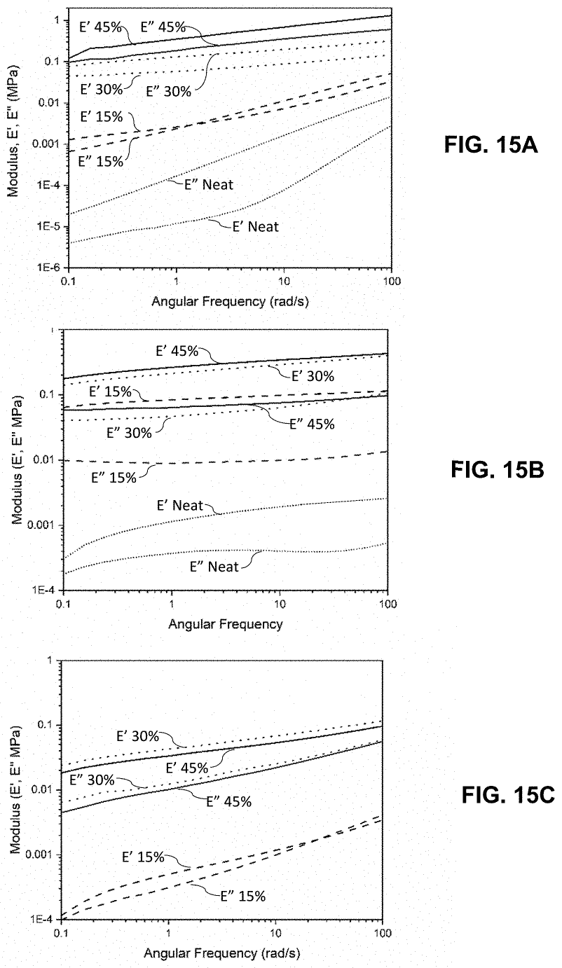

Corresponding graphs for polymer networks formed of other OPA can be seen in FIG. 15A (PR-AA), FIG. 15B (HMDA50-SA), and FIG. 15C (HMDA25-AA) with 0-45 wt. % CC lignin. The general trend was observed that increasing lignin content resulted in a faster onset of the yield and flow point (i.e., at lower strain values). The curves for all strain sweeps represent smooth transitions to the flow point except for polymers composed of HMDA50-SA (FIG. 15B). The more rigid character of this polymer structure results from the higher content (50%) of hard segments composed of HMDA. More inconsistent behavior was observed for polymers composed of HMDA25-AA (FIG. 15C). At 15 wt. % lignin, these compositions observed γₚ and γ_{f} at lower strain values than at higher lignin compositions. This behavior was noticed with the neat material as well and may be due to additional polymerization reactions occurring between the multiple phases present in the polymer at the high temperatures used for the rheological study. With higher lignin concentrations, polymers composed of HMDA25-AA exhibit more consistent behavior as the reactive groups have bonded to the CC lignin creating more homogeneous polymer networks.

These results correspond to the data from Soxhlet extraction showing that a significant increase in crosslinking occurred between samples with 15 wt. % and 30 wt. % lignin, while smaller residual values and gains in modulus are observed between samples with 30 wt. % and 45 wt. % lignin. The increased modulus and homogenous nature of samples with 30 wt. % lignin content indicate a material with favorable characteristics for high value applications.

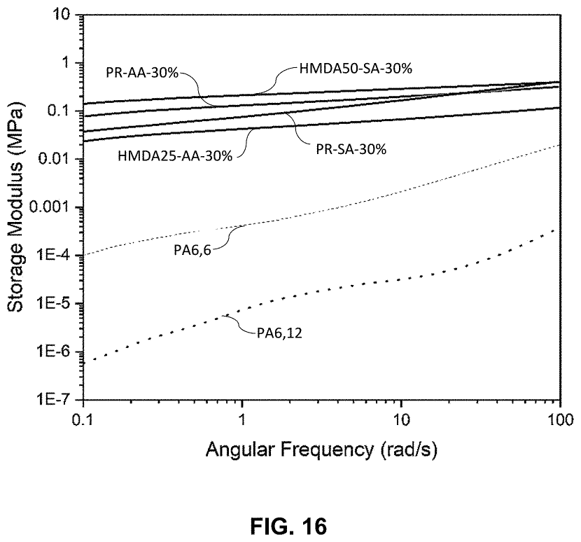

In order to compare all polymer systems, FIG. 16 displays E′ for 30 wt. % lignin composition of polymer networks formed of each OPA. Consistent behavior is observed based on the hard segment composition of the OPA and the magnitude of E′. HMDA50-SA displays the highest E′ for the neat polymer (FIG. 13B) and maintained the highest E′ at 30 wt. % loading (FIG. 16). The E′ of PR-AA-30 wt. % was above that of PR-SA-30 wt. % based on the same considerations: AA (adipic acid, C6) contains shorter aliphatic chains compared to SA (sebacic acid, C10). Shorter aliphatic chains give strength to the network structure by minimizing molecular motion and enhancing rigidity. The lowest value for E′ was observed for polymers composed of HMDA25-AA. The multiple phases of the neat HMDA25-AA did not give rise to a developed crosslinking network of the same magnitude as did OPAs of more homogeneous composition. These results point to the importance of the neat OPA and the influence that it has on the final network structure of the cured resins. As with linear thermoplastic polymers, single phase crystalline materials tend to result in higher mechanical properties.

The storage modulus at 30 wt. % lignin composition was also compared to that of traditional PA6 and PA6,12 in FIG. 16. The new polymer structure afforded by the reaction of OPAs with CC lignin created much higher modulus in the melt compared to traditional polyamides. This corresponds to one of the objectives of disclosed materials, namely, a high melt strength polyamide-based material facilitating traditional thermal techniques such as extrusion and injection molding.

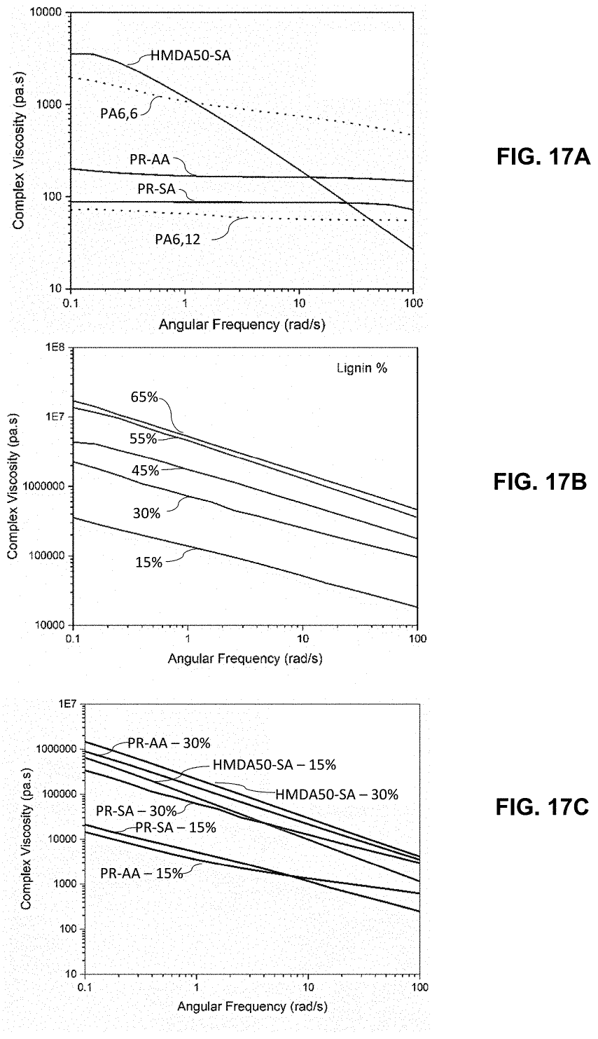

The complex viscosities of the cured materials are tied to the changes in E′ and E″. FIG. 17A presents the complex viscosities for the neat OPAs. FIG. 17B provides a detailed breakdown of each lignin loading level for polymers composed of PR-SA. FIG. 17C provides a comparison of different OPAs at 15 wt. % and 30 wt. % loading. Low melting point OPAs (PR-SA, PR-AA) contain a broad Newtonian plateau as neat polymers seen by the constant viscosity in the frequency range tested (FIG. 17A). Newtonian behavior is consistent with linear polymers in a narrow molecular weight distribution. The high melting point OPAs displayed a much different behavior. HMDA50-SA displayed a non-Newtonian curve through shear thinning behavior with increasing angular frequency. Shear thinning is a result of large molecular weight distributions present in the polymer sample. Only HMDA50-SA is given in FIG. 17A due to inconsistent results observed for HMDA25-AA.

Complex viscosity values were determined at a temperature of 120° C. The complex viscosity of neat OPAs undergo a 3-4 order of magnitude increase with the reaction with CC lignin. FIG. 17B shows the effect of lignin loading on the complex viscosity of polymer networks formed with PR-SA. Compared to neat PR-SA, the reaction with 15 wt. % lignin causes a 3 order of magnitude increase in the complex viscosity (Table 6 and FIG. 167). When increasing to 30 wt. % lignin, another order of magnitude increase is observed with smaller gains at each subsequence lignin loading. This behavior is also observed for polymers composed of PR-AA. Given the relatively large increase in complex viscosity between 15 wt. % and 30 wt. % lignin loadings, it may be questioned whether a different polymer structure is at work. Soxhlet extraction has shown a significant increase in crosslinking when the lignin loading reaches 30 wt. %. At 15 wt. % lignin, a structure more commensurate with chain extension or branching could be in effect. For linear polymers, the viscosity generally follows the 3.4 power law (η˜M^{3.4}) where η is the viscosity and M is the molecular weight. Although lignin is not a linear molecule, even a weak correspondence to the power law could reveal topological details about the polymer structure between the 15 wt. % and 30 wt. % loadings. Table 6, below, shows the values for complex viscosity for chain extension assuming one OPA reacts with one CC lignin molecule. The molecular weight of each component was used to estimate the complex viscosity of a chain extended polymer using a multiplier gained from the 3.4 power law. The result shows that at 15 wt. % lignin content, the observed complex viscosity corresponds to the same order of magnitude to the viscosity calculated through the power law. At 30% lignin, over an order of magnitude increase in η* is observed showing deviant behavior to the power law. Given these results, it is most likely that chain extension is the dominant structure at low lignin loading whereas at higher lignin contents, increased crosslinking occurs causing the significantly higher values for η* and E′ discussed above. This behavior is only consistent with polymers composed of the low Tₘ OPAs as HMDA50-SA has very similar η* values for both 15 wt. % and 30 wt. % lignin loadings (FIG. 17C).

TABLE 6

| | η* of | η* estimated | η* at 15 | η* at 30 |
|---|---|---|---|---|
| OPA in | Neat | for chain | wt. % | wt. % |
| PAU | OPA | extension | Lignin | Lignin |
| PR-SA | 88.3 pa · s | 27,000 pa · s | 21,000 pa · s | 340,000 pa · s |
| PR-AA | 201 pa · s | 44,000 pa · s | 14,000 pa · s | 900,000 pa · s |

The complex viscosity of PA6,6 and PA6,12 is also represented in FIG. 17A showing surprising correspondence to the neat low Tₘ OPAs (c.f. PR-SA, PR-AA in Table 6 with PA6,12 in FIG. 17A) and to the high Tₘ OPA HMDA50-SA (c.f. PA6,6). The design of these OPAs was, in fact, to mimic traditional polyamides yet with processing temperatures that enable reactions with CC lignin. After reaction with CC lignin, the new poly(amide-urethanes) exhibit 3-4 orders of magnitude higher η* than PA6,6 and PA6,12, creating new materials with enhanced processing characteristics. These new polymers with enhanced melt viscosity address the problems associated with low bead strength typically encountered with high use commodity polyamides.

### Example 2

A two-stage process composed of compression molding and thermoforming was used to create a prototype molded product of a poly(urethane amide) as described herein. Different concentrations of the lignin component with the OPA were tested to examine the flexibility and strength of sheets resulting from compression molding.

Tensile testing was carried out on sheets synthesized from different poly(urethane amide) polymers formed with the PR-SA polyamide described in Example 1 and increasing amount of CC lignin. As expected, increasing the amount of lignin from 15 wt. % to 30 wt. % caused an increase in the ultimate tensile strength of the molded material and a decrease in the flexibility (strain) compared to the neat polyamide (Table 7). Between 0% (neat polyamide) and 15 wt. % CC lignin, no significant difference in tensile strength was observed as both recorded ˜12.3 MPa. At 30 wt. % lignin, the crosslinking density of the samples increased, given rise to stronger tensile strengths with an average of 15.9 MPa. This data correspond to rheological analysis carried out on the polymers and described in Example 1 that shows a large increase in melt strength between 15 wt. % and 30 wt. % lignin samples corresponding to a higher crosslinking degree (FIG. 14A, FIG. 14B). At 15 wt. %, it is hypothesized that chain extension with lignin is the predominant interaction, where at 30 wt. % lignin, crosslinking mechanism begin to influence the mechanical properties of the polymer.

TABLE 7

| | Tensile | Ultimate |
|---|---|---|
| Sample | Strength | Strain |
| Neat Polyamide | 12.4 | 7.9 |
| 15 wt. % Lignin | 12.3 | 4.4 |
| 30 wt. % Lignin | 15.9 | 5.4 |

While certain embodiments of the disclosed subject matter have been described using specific terms, such description is for illustrative purposes only, and it is to be understood that changes and variations may be made without departing from the spirit or scope of the subject matter.

What is claimed is:

1. A bio-based non-isocyanate poly(urethane amide) comprising the reaction product of a cyclocarbonated polymer and an amine-terminated oligomeric polyamide, wherein a segment of the poly(urethane amide) derived from the cyclocarbonated polymer includes aromatic and/or cyclic functionality, the poly(urethane amide) polymer having a bio-based carbon content of about 90% or greater as determined by radiocarbon dating according to ASTM D6866-20, the poly(urethane amide) polymer being free of isocyanate reaction products.

2. The bio-based non-isocyanate poly(urethane amide) of claim 1, wherein the cyclocarbonated polymer comprises cyclocarbonated lignin or cyclocarbonated depolymerized lignin.

3. The bio-based non-isocyanate poly(urethane amide) of claim 1, wherein the poly(urethane amide) has a melt temperature of about 200° C. or less.

4. The bio-based non-isocyanate poly(urethane amide) of claim 1, wherein the poly(urethane amide) has one or more of the following characteristics:
a storage modulus of about 0.01 MPa or greater;
a loss modulus of about 0.01 MPa or greater; and
a complex viscosity as determined at an angular frequency of 1 rad/s and at a temperature of 120° C. of about 1,000 Pa·s or greater.

5. The bio-based non-isocyanate poly(urethane amide) of claim 1, wherein the poly(urethane amide) exhibits a linear viscoelastic region at a strain value of from 0 to about 10%.

6. The bio-based non-isocyanate poly(urethane amide) of claim 1, wherein the amine-terminated oligomeric polyamide comprises the reaction product of a diamine and a bio-based carboxylic acid.

7. The bio-based non-isocyanate poly(urethane amide) of claim 6, wherein the diamine comprises a fatty acid diamine.

8. The bio-based non-isocyanate poly(urethane amide) of claim 7, wherein the diamine comprises a combination of multiple diamines.

9. The bio-based non-isocyanate poly(urethane amide) of claim 1, wherein the cyclocarbonated polymer comprises a cyclocarbonated polyol that includes the aromatic and/or cyclic functionality within the polyol.

10. The bio-based non-isocyanate poly(urethane amide) of claim 9, wherein the polyol is a linear or branched system, and optionally includes a linear aliphatic portion in conjunction with the aromatic and/or cyclic functionality.

11. A method for forming a bio-based non-isocyanate poly(urethane amide) comprising reacting an amine-terminated oligomeric polyamide with a bio-based cyclocarbonated polymer that includes aromatic or cyclic functionality within the polymer.

12. The method of claim 11, wherein the amine-terminated oligomeric polyamide comprises the reaction product of a bio-based diamine and a bio-based dicarboxylic acid.

13. The method of claim 11, further comprising forming the amine-terminated oligomeric polyamide.

14. The method of claim 11, wherein the bio-based cyclocarbonated polymer comprises the reaction product of a bio-based polyol comprising the aromatic and/or cyclic functionality with a carbonate.

15. The method of claim 14, wherein the polyol is a linear or branched system.

16. The method of claim 14, wherein the polyol comprises a linear aliphatic portion in conjunction with the aromatic and/or cyclic functionality.

17. The method of claim 14, wherein the carbonate is an organic bio-based carbonate.

18. The method of claim 11, wherein the bio-based cyclocarbonated polymer comprises cyclocarbonated lignin or cyclocarbonated depolymerized lignin.

19. The method of claim 11, further comprising forming the bio-based cyclocarbonated polymer.

20. The method of claim 19, wherein the bio-based cyclocarbonated polymer is formed according to a two-step reaction process comprising reacting a bio-based polyol comprising the aromatic and/or cyclic functionality with a first carbonate to form an oxyalkylated polyol and reacting the oxyalkylated polyol with a second carbonate.
